(19) United States
(12) Patent Application Publication
(10) Pub. No.: US 2009/0071831 A1
(43) Pub. Date: Mar. 19, 2009

(54) Methods and systems for producing arrays of particles

(75) Inventors: Christopher S. Chen, Princeton, NJ (US); Darren Gray, La Jolla, CA (US); John Tan, Brentwood, CA (US); Joel Voldman, Belmont, MA (US)

Correspondence Address: EDWARDS ANGELL PALMER & DODGE LLP, P.O. BOX 55874, BOSTON, MA, 02205, US

(73) Assignee: The Johns Hopkins University, Baltimore, MD (US)

(21) Appl. No.: 10/587,817

(22) PCT Filed: Feb. 4, 2005
(86) PCT No.: PCT/US05/03368

§ 371 Date: Oct. 8, 2008

Related U.S. Application Data
(60) Provisional application No. 60/541,860, filed on Feb. 4, 2004.

(51) Int. Cl. G01N 27/26; C25B 9/06

(52) U.S. Cl. 204/547; 204/643

(57) ABSTRACT

The invention provides apparatus and methods for arraying particles on a surface using dielectrophoresis.

### CROSS-REFERENCE TO RELATED APPLICATIONS

This application claims the benefit of U.S. Provisional Application Ser. No. 60/541,860, filed Feb. 4, 2004, the contents of which are hereby incorporated by reference in their entirety.

### BACKGROUND OF THE INVENTION

Recently, the need for precisely positioning cells in micrometer-scale cultures has arisen in the miniaturization of experimental systems. Such miniaturization leads to reductions in cost of reagents and in consumption of valuable cells, allows for automated handling of experiments, and increases speed of experiments. Miniaturized cell culture systems are being used to increase the speed of discovery in basic cell biology, to construct cell-based devices, and to explore the production of engineered tissues.

Several passive methods are available to create arrays of cells or other particles on a surface. These methods generally fall into two categories: chemical patterning, in which adhesive and non-adhesive areas are patterned onto a physical surface; and topological patterning in which wells or other topological regions are formed on a surface. A suspension of cells is then flowed onto these substrates, such that cells settled randomly onto the surface and either are ‘trapped’ by the surface or are not, depending on the location each cell lands. Thus, both methods control the regions in which cells or other particles remain using passive approaches, and result in random statistical distribution of the cells or particles across the surface. Thus, the methods cannot precisely position individual cells or other particles, and further cannot pattern multiple types of cells or other particles in precise stoichiometry at specific regions of the substrate.

Methods such as inkjet delivery of reagents, or laser tweezers, are primarily serial methods; that is, they only deliver compounds to one location at a time.

Dielectrophoresis (“DEP”) refers to the force experienced by particles suspended in a fluid medium when exposed to an applied electric field gradient (see, e.g., FIG. 1). Due to the applied electric field gradient, differences in dielectric polarization between the particles and the fluid medium cause the particles to experience the dielectrophoretic force. A particle, which is more polarizable than the surrounding media, is pulled toward a field maximum.

A particle's structural and physico-chemical properties can contribute towards its DEP response. For example, some fundamental electrical properties of cells, such as membrane capacitance, membrane resistance and cytoplasmic conductance, affect their DEP response. These properties also reflect a cell's ability to maintain ion balances and are a measure of metabolic work and biological organization. Thus, DEP can provide a non-invasive method for determining the electrical properties of cell populations, down to the single cell level.

DEP can be used to separate mixtures of particles. DEP particle separation exploits dielectrophoretic forces that are experienced by particles when a non-uniform electric field interacts with the field-induced electrical polarization of the particles. Depending on the dielectric properties of the particles relative to the suspending medium (e.g., liquid), these forces can be either positive or negative. For a particular set of conditions, the motion of one type of particle can be dominated by a DEP force (e.g., an attractive or repulsive DEP force), while the motion of another type of particle is not (e.g., where particle motion can be dominated by the fluid flow or gravity). Under such circumstances, DEP can be used to separate a mixture of the two particle types.

DEP has been successfully used to manipulate particles, ranging from 10 nm to 100 microns, in this manner. However, most previous attempts have only been able to control the general position of large groups of cells or other particles (see, e.g., Pethig et al., Trends Biotech. 15:426-432 (1997)) and unable to precisely position individual cells or other particles. Additionally, these general positions are subject to the geometries which are utilized to create the non-uniform electric field(s). One previous approach has achieved single-particle specificity (J. Voldman et al., Biophys J. 80:531-541 (2001)). However, due to the multiple (4) electrical connections required for each trap, these traps have only been applicable to limited 1 dimensional arrays, i.e. lines, of trapped particles. Additionally, this previous approach requires electrodes which protrude significantly past the plane of the substrate. These protruding electrodes interfere with the fluid flow used as the destabilizing force, and would complicate analysis of cell behavior, were such an approach used to study cell locomotion after adhesion to the substrate. Finally, a non-planar surface precludes or interferes with the use of a variety of techniques commonly used to modify surface chemistry, such as microcontact printing and lithography.

U.S. Published application No. US2004226819 (the contents of which are hereby incorporated by reference) discloses a filter for filtering fluids using dielectrophoresis in a coiled substrate.

U.S. Pat. No. 6,692,952 (the contents of which are hereby incorporated by reference) describes devices for capturing cells in wells by means of bubbles.

U.S. Pat. No. 5,355,577 (the contents of which are hereby incorporated by reference) describes the use of charge leakage through holes in one plate of a parallel-plate capacitor to generate dielectrophoresis and trap particles for integrated circuit manufacture. According to the disclosure of this patent, particles are trapped outside of the two plates. This configuration requires relatively high voltages to operate (e.g., 8 kV); such voltages may be injurious to certain particle types, and the particle traps are not independently activated.

### SUMMARY OF THE INVENTION

The current invention uses dielectrophoresis (DEP) to simultaneously position large numbers of cells (or other small particles) in any pre-selected planar coordinates with single cell precision. Such patterning of cells is independent of the chemistry and topology of the surface on or near which the array is formed. The same DEP-based technique used to pattern cells can also be applied to positioning one or more types of other solid, semisolid, or liquid particles in arrays with single particle precision.

In one embodiment, the invention provides an apparatus for arraying particles, the apparatus comprising: a) a substrate comprising an array of electrodes; b) a counter-electrode plate substantially parallel to the array of electrodes; and c) a fluid inlet for permitting a particle-containing fluid to flow between the array of electrodes and the counter-electrode plate.

In preferred embodiments, the apparatus further comprises a voltage source for applying a voltage between the array of electrodes and the counter-electrode; preferably, the voltage source provides a voltage of not greater than about 100 volts/mm. In certain preferred embodiments, the substrate comprises at least one cell-adhesive region and at least one non-cell-adhesive region; in preferred embodiments, the cell adhesive region comprises a layer of fibronectin or collagen. In preferred embodiments, the apparatus further comprises a fluid outlet. In certain preferred embodiments, the electrode array comprises at least 50 electrodes, more preferably at least 100 electrodes. In certain preferred embodiments, each electrode of the electrode array is less than 100 microns (or 10 microns) in diameter. In certain preferred embodiments, each electrode can be energized independently of other electrodes; all or some of the electrodes can be energized simultaneously.

In another aspect, the invention provides a method for arraying particles on a surface. The method includes the steps of a) providing an apparatus comprising: i) a substrate comprising an array of electrodes, ii) a counter-electrode plate substantially parallel to the array of electrodes, and iii) a fluid inlet for permitting a flow of particle-containing fluid between the array of electrodes and the counter-electrode plate; b) flowing a particle-containing fluid between the array of electrodes and the counter-electrode plate; and c) subjecting the fluid to an electric field by applying an electric potential to the array of electrodes under conditions such that particles in the fluid are arrayed on a surface of the substrate.

In preferred embodiments, the particles are cells. In certain preferred embodiments, the substrate comprises at least one cell-adhesive region and at least one non-cell-adhesive region; the cell adhesive region can comprise a layer of fibronectin or collagen.

### BRIEF DESCRIPTION OF THE DRAWINGS

FIG. 1 is a representation of dielectrophoretic force acting on a particle in an electric field.

FIG. 2 depicts construction of an electrode array of the invention.

FIG. 3 shows trapping of cells in an electrode array.

FIG. 4 shows groups of electrodes in an array.

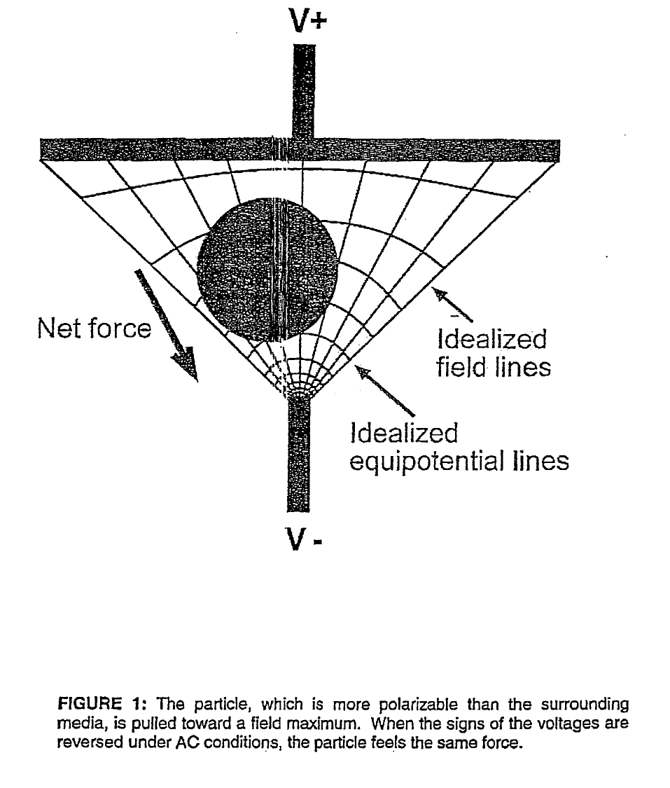

### DETAILED DESCRIPTION OF THE INVENTION

This invention uses forces generated by dielectrophoresis to actively move individual cells or other particles to precise locations. Because this is an electrical force that can be reproduced many times across a surface, it can be used to move many particles, e.g., cells (thousands to millions) simultaneously. Therefore, arbitrary patterns and stoichiometries of multiple cells types, or multiple types of other particles, can be formed using this active method. Because dielectrophoresis-based trapping (DEP trapping) is orthogonal to surface chemistry and topology, it can also be used to confine cells or other particles to subsets of adhesive regions or depressed wells.

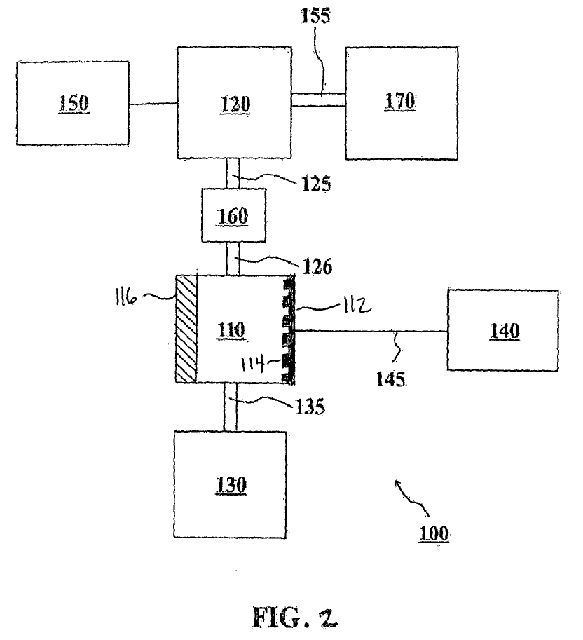

In one embodiment (referring to FIG. 2), a dielectrophoresis (“DEP”) system 100 includes a chamber 110 defined by substrate 112 carrying an array of electrodes 114 and a substantially planar counter-electrode 116 parallel to and opposed to substrate 112. A supply reservoir 120, a collection reservoir 130, and a pre-filter 160 are connected to the chamber 110. Supply reservoir 120 is connected to pre-filter 160 by a supply tube 125. Pre-filter 160 and collection reservoir 130 are connected to filter 110 by a supply tube 126 and an outlet tube 135, respectively. A buffer reservoir 170 is connected to the supply reservoir 120 by a supply tube 155. A signal generator 140 is connected to electrodes 114 by a cable 145. The system 100 also includes a pump 150, which is connected to supply reservoir 120.

During operation, pump 150 pumps fluid from supply reservoir 120 to chamber 110 through supply tube 125, pre-filter 160, and supply tube 126. One or more types of particle (e.g., cells) are suspended in the fluid. The particles within the fluid experience a dielectrophoretic force in chamber 110 in the vicinity of electrodes 114 and become adhered to substrate 112. Fluid exits chamber 110 through tube 135 and collects in reservoir 130.

In order to separate particles from the fluid, signal generator 140 applies a voltage across opposing electrode arrays disposed on a surface of a substrate in substrate 112. The electrodes and substrate are described below. The applied voltage generates an electric field between energized electrodes. Depending on the dielectric properties of the particles and the fluid, the electric field can cause particles to be attracted to or repelled from the electrodes.

In general, the amplitude and frequency of the applied voltage depends on the electrode geometry and type of target particle and fluid being filtered. In some embodiments, power supply 140 can apply a DC voltage to the electrodes. Alternatively, an AC voltage can be applied. The AC waveform can be sinusoidal, saw-tooth, triangular, square, or some other complex waveform. In some embodiments, the waveform can be a superposition of multiple sinusoidally-varying waveforms. The frequency of the AC waveform is usually selected to provide a desired DEP response in a target particle. In most embodiments, the frequency is in the range of MHz or greater (e.g., about 1 MHz, 100 MHz, 1 GHz, 10 GHz, or 100 GHz). In cases where the waveform is non-sinusoidal, the frequency refers to the number of times the waveform repeats itself per unit time.

Pre-filter 160 prevents undesirably large particles from entering chamber 110. In some embodiments, pre-filter 160 includes a porous membrane that passes particles less than a certain threshold size. For example, the threshold size can be the maximum anticipated size of the target particle, and pre-filter 160 can remove larger, non-target particles from the fluid prior to filtering. Although pre-filter 160 in system 100 is shown as a separate unit, in other embodiments the pre-filter can be included in as a component within chamber 110. Alternatively, pre-filtering can be performed in a system separate from system 100, or not at all. Examples of filters include silicon and ceramic filters with pore sizes designed to exclude undesirable particles. Silicon and ceramic filters may be advantageous because cross-flow across the surface of the filter can be used to remove the undesirable particles, pore sizes may be uniform and/or high pore densities can be achieved (providing the possibility of high flow rates). This can prevent the pre-filter from becoming blocked or clogged.

In some cases, particles in the fluid can become clumped together to form an agglomerate of particles too large to pass through chamber 110. In such cases, system 100 can include one or more additional components to break up agglomerates of particles prior to or during their passage through chamber 110. For example, chamber 110 can include a transducer which introduces a density variation (e.g., a periodic density variation, such as an ultrasonic pulse) in, the fluid, causing agglomerations to break up. Such a transducer can be included as a separate component in the path from supply reservoir 120 to chamber 110, or as a component of the filter, pre-filter, or supply reservoir. Examples include scaleable piezoelectric devices to sonicate the sample at frequencies that range from 0.1 Hz to 100 kHz at a force amplitude that breaks up particle agglomerations, preferably without causing excessive mechanical stress which could lead to particle disintegration or cell lysis in embodiments where the particles are cells. Alternatively, or additionally, other methods to disperse agglomerations can be used, such as applying localized turbulence in the sample by applying a disruptive mechanical force to break up particle agglomerations.

In certain preferred embodiments the system components are positioned so that the fluid is pumped upwards, against the force of gravity. This can reduce sedimentation of particles in the system.

Pump 150 can be any pump that provides appropriate pressure to the fluid so that it flows through the chamber at an appropriate rate. An appropriate rate is one at which fluid flow through the filter is laminar (i.e., ideally turbulence in the filter should be avoided), but still sufficiently fast to treat fluid volumes in a reasonable time. The flow rate will depend upon such factors as the type of particle to be trapped, the dimensions of the chamber and the electrode array, the viscosity of the fluid, the applied electric field, and the like. Suitable types of pump include a peristaltic pump, a diaphragm pump, or pumps that can be operated at low speeds and low shear rates. A manually operated pump (e.g., a syringe or hand pump) can also be used. In certain embodiments, fluid can be flowed through the filter under the force of gravity and no pump is necessary. In certain preferred embodiments, however, the fluid is pumped upward through the chamber to reduce bubbles in the chamber and to act as a balancing force against gravitational sedimentation forces.

In certain embodiments, system 100 can be adapted to treat smaller volumes (e.g., about 10 milliliters, one milliliter, 100 microliters, or 10 microliters or smaller) or larger volumes (e.g., about 100 milliliters, 500 milliliters, one liter or more). Furthermore, the flow rate of the fluid can vary as desired. In some embodiments, the rate is less than about 1 milliliter per minute (e.g., about 500 microliters per minute, 100 microliters per minute, 10 microliters per minute, or less). Alternatively, the rate can be higher than about one milliliter per minute (e.g., about five milliliters per minute, 10 milliliters per minute, 50 milliliters per minute, 100 milliliters per minute or higher).

Although in system 100 pump 150 applies a positive pressure to move fluid through chamber 110, in other embodiments the pump 150 can be configured to draw fluid from supply reservoir 120 to chamber 110 by applying a negative pressure. To apply a negative pressure, pump 150 can be connected to collection reservoir 130 or outlet tube 135. In this configuration, the pump reduces the fluid pressure on the outlet side of chamber 110 relative to the inlet side, thereby drawing fluid from supply reservoir 120 into and through chamber 110. One advantage of pumping the fluid using a negative pressure is that the system can be less likely to leak fluid, e.g., through corrupt seals, because pressure in the filter is lower than ambient pressure.

During operation, fluid pumped from the supply reservoir enters the chamber 110 through the inlet port. The fluid penetrates the space between the array of electrodes 114 and the counter-electrode 116. During the pumping, the signal generator energizes electrodes 114, generating an electric field adjacent the electrodes in the space between the substrate and the counter-electrode. Depending on the dielectric properties of the fluid and the particles suspended in the fluid, the electric field can cause the particles to experience a DEP force. In preferred embodiments, the applied electric field causes the electrodes to attract a target particle type. The target particles remain next to the electrodes, while non-target particles (if also present in the fluid) continue to flow through the chamber with the fluid. Accordingly, target particles are removed from the fluid exiting the chamber.

In some embodiments, an attractive dielectrophoretic force balances the rate of flow of non-target particles through the chamber. Balancing these forces can increase the amount of time particles spend in the chamber without reducing fluid velocity, which can further improve the purity and recovery of the separation process. Other means of improving separation efficiency can be combined in the separation procedure by altering physical and/or chemical properties of the fluid and/or particles to alter the magnitude of the dielectrophoretic force. Examples of properties that can be altered include the sample conductivity, permittivity, osmolarity, temperature and/or pH.

Particles attracted to the electrode array can be purged from the chamber by adjusting the applied electric field so that the electrodes no longer attract them. Depending on the interaction between the target particles and the electrode material and/or substrate material, the applied voltage to the electrodes can either be reduced (or switched off) or the frequency varied to change the nature of the DEP force. For example, in situations where the surface interaction between the particles and the electrodes causes the particles to stick to the electrodes, it may be necessary to remove the particles by applying a negative DEP force. However, where the interaction is weak, the viscous force from flowing fluid and/or gravity may be sufficient to remove the target particles from the electrodes.

System 100 can be used to increase the concentration of a target particle in a fluid volume.

Where the chamber volume is smaller than the volume to be filtered, the concentration of target particles in the chamber increases as more of them are filtered from the fluid. Ultimately, after releasing the trapped particles from the electrodes, the volume of fluid flushed from the chamber has a higher concentration of the target particles than the initial sample.

It will be appreciated that different particles may respond differently to an electric field applied across the electrode array. Accordingly, DEP systems of the invention can operate at frequencies at which the DEP response of one type of particle differs from other types of particle. Where different types of particle are suspended in the fluid, a differential response can be used to move the different types of particle to different regions of the chamber, facilitating their separation.

The distance between the electrode array and the counter-electrode affects the proximity of particles in the chamber to the electrodes. In addition to affecting the proximity of particles to the electrodes, factors influencing the choice of separation distance include the type of particles to be filtered and type of fluid medium. Substrate separation should be large enough to accommodate the size of the particles (i.e., substrate separation should be larger than the diameter of the largest particles to be passed through the chamber). Additionally, the separation distance should be sufficiently large to allow the fluid medium to flow through the chamber under the force of the pump without turbulent flow arising. The thickness and mechanical properties of the substrate and electrode materials can also influence a designer's selection of the separation distance. In some embodiments, the separation distance can be on the order of microns (e.g., between about two and 20 microns). More typically, separation distance is on the order of tens to hundreds of microns (e.g., about 50 microns, 100 microns, 200 microns, 300 microns, 500 microns). In some embodiments, the separation can be on the order of millimeters or larger (e.g., more than about 1 millimeter, 2 millimeters, 5 millimeters, 10 millimeters). In certain biological applications (e.g., where the particles to be trapped are biological cells), the separation distance is between 100 microns and 1 millimeter (e.g., between about 300 microns and 500 microns).

In certain embodiments, the counter-electrode can take the form of a counter-electrode array opposed to the electrode array 114 on substrate 112. In certain embodiments, the opposing electrode arrays include interdigitated electrodes. The dimensions of the interdigitated electrodes can vary as desired. In some embodiments, the electrodes are about five or more microns wide (e.g., about 10 microns, 20 microns, 50 microns, 100 microns) and about 20 or more microns long (e.g., 30 microns, 40 microns, 50 microns, 75 microns, 100 microns, 200 microns, 500 microns). Furthermore, the separation between adjacent electrodes can vary. In some embodiments, the separation between adjacent electrodes is greater than the electrode's width. The separation can be, for example, more than about 10 microns (e.g., about 20 microns, 30 microns, 50 microns, 100 microns, 200 microns, or more).

The electrode array may have, e.g., more than 50 electrodes, 100 electrodes, 250 electrodes or more.

Other electrode geometries can also be used. In general, electrode geometry is selected to provide a desired electric field profile. Examples of other electrode geometries include polynomial electrodes, castellated electrodes, arrays of posts or stub electrodes, interdigitated zig-zag electrodes or curved electrodes whose periodic pattern may be fixed, or varying in pitch and/or amplitude.

In general, the substrate can be made from any material that is compatible with the electrode material, and does not adversely interact with the components of the sample to be filtered. Use of a flexible substrate material allows planar processing techniques to be used to form an electrode array (e.g., various established deposition and patterning techniques used in printed circuit board manufacturing, micro electro-mechanical system (MEMS) manufacturing and the semiconductor and flat panel display industries). The substrate can be polymeric, such as including polyimide, polyethylene, polypropylene, polyester, polystyrene, poly methylmethacrylate or polyacrylamide.

Electrode arrays can be formed on the substrate using lithographic techniques. For example, the electrode array can be etched from a monolithic layer of the electrode material (e.g., chromium, gold, palladium, or vanadium) coated on the surface of the substrate. The substrate can include an adhesion layer to promote adhesion of the coated conductor to the substrate. Chrome is an example of an adhesion layer for gold electrodes. Alternatively, the electrode array can be printed onto the substrate, or transferred onto the substrate, e.g., using a transfer adhesive.

In some embodiments, one or more additional layers can be provided on top of the electrodes and/or substrate surface. Surface coatings on the electrode surfaces and substrates can be used to improve compatibility of the filtration device to the target samples. For example, surface coatings can reduce any potentially adverse reactions between the substrate material and the particles. Copper and chromium, which are examples of electrode materials, can be toxic to cells. In such cases, a coating on top of the electrodes can reduce leaching of the electrode material into the solution, thereby reducing any toxic interaction between the electrode material and the particles. In some embodiments, surface coatings can be selected to provide good surface wetting properties that, for example, help to reduce bubble formation by making the surface hydrophilic. Alternatively, or additionally, surface coatings can be selected to create a surface charge (e.g., a negative surface charge) to reduce surface adhesion of cells. In addition to their functional property or properties, coatings can be thin (e.g., less than about 50 microns thick), uniform, stable, inert, sterilizable, durable and/or have good adhesion to the electrode and substrate materials.

In embodiments where the electrode and/or substrate surfaces are coated with substances known to enhance or reduce cell adhesion, the coating can improve selective trapping of certain particle types, or to quantify particle adhesion effects. For example, certain types of fibroblasts adhere well to surfaces coated with the glycoprotein known as fibronectin, but not to surfaces coated with cytotactin. Likewise, B-lymphocytes and T-lymphocytes are known to have significantly different adhesion tendencies to different types of glycoprotein surfaces. Known cell adhesive substances that can be used as a coating include proteins such as fibronectin or laminin, antibodies or fragments of antibodies, peptides or peptides conjugated to an inert protein such as serum albumin. In certain embodiments, at least portion of the substrate is a cell-adhesive region.

Although surface coatings are often homogenous, in some embodiments, different portions of the electrode and/or substrate surface can be coated with different materials. For example, opposing electrodes (or electrode arrays) can be coated with different materials. One example of this is where opposing electrode arrays are coated with materials providing different degrees of adhesion to particles. In certain preferred embodiments, the substrate comprises at least one non-cell-adhesive region, i.e., a region to which cells do not substantially adhere under the conditions within the chamber. In preferred embodiments, a non-cell-adhesive region comprises a layer of hydrogel (such as polyacrylamide or agarose) or polyethylene glycol.

In many embodiments, fluid flow shear stress should be sufficiently small so that the stress does not damage particles in the fluid. The threshold for particle damage depends on the particle type. For example, red blood cells can be damaged at shear stresses of 150 N/m² or more, while lymphocytes can be damaged at shear stresses 20 N/m². In some embodiments, fluid flow shear stress in the filter is less than about 10 N/m², such as less than about 1 N/m².

In some embodiments, the conductivity of the suspending fluid can be adjusted to change the DEP force experienced by a particle type. For example, the fluid conductivity can be adjusted over many decades of magnitude (e.g., 0.1-1000 mS/m). The conductivity of the suspending media can be altered by flowing a medium through the chamber from the supply reservoir 120 that has a higher or lower conductivity than that of the original suspending media. In some embodiments, this can be achieved by filling the sample reservoir 120 with fluid from the buffer reservoir 170, resulting in the fluid being filtered having a time-varying conductivity.

Typically, with increasing conductivity of the sample, a positive DEP force acting on a cell becomes weaker for any fixed AC voltage. Thus, an introduction of a fluid having higher conductivity at the inlet port will result in a time-varying conductivity of the fluid in the filter, which can result in differential releasing of target particles from the filter allowing fractionation to be achieved. In addition, increased fluid conductivity often increases constraints related to power dissipation and heat generation can be placed on the maximum voltage that can be applied to the electrodes. Therefore, in many embodiments, samples of low conductivity can be pumped through the chamber at higher fluid velocities compared to similar samples of high conductivity. The concept of a time-varying conductivity, also referred to as a “conductivity gradient,” is described by G. H. Markx, P. A. Dyda, and R. Pethig, in “Dielectrophoretic Separation of Bacteria using a Conductivity Gradient,” J. Biotechnology 51, pp. 175-180 (1996), the contents of which are hereby incorporated by reference in their entirety.

Although the foregoing description refers to creating a time-varying conductivity in the sample, the disclosed methods can be used to enhance fractionation purity and recovery of target particles for each, or any combination of, buffer medium by changing conductivity, permittivity, pH, osmolarity and/or temperature. Furthermore, while in system 100 buffer reservoir 170 is configured to supply a buffer medium to chamber 110 through supply reservoir 120, alternatively, buffer reservoir can be configured to supply the buffer medium to other components of the system. For example, buffer reservoir 170 can supply the buffer medium directly to chamber 110, or to chamber 110 through pre-filter 160, or through one or more of the tubes connecting system components. In some embodiments, system 100 includes a valve to control flow of the buffer medium from buffer reservoir 170.

In some embodiments, the electrodes and signal generator are configured to provide a traveling wave electric field.

If the voltage frequency for a particular suspending medium conductivity is in the range where a particle type experiences a positive DEP force, particles will be attracted to and immobilized at the electrodes. If a particle experiences a negative DEP force, it will be repelled from the electrodes. When a particle is forced away from the electrodes under the influence of negative DEP, the time-averaged traveling field force acting on the particle can propel the particle in a direction perpendicular to the electrodes. The speed and direction of this movement are determined by the physicochemical properties of the particles, the applied field magnitude and frequency, and the dielectric properties of the suspending medium.

Depending on the direction of the induced force exerted on the particles, traveling field DEP can be used to move a target particle type towards the inner layers or outer layers of the coiled substrate. In some embodiments, the inlet and outlet ports can be adapted to preferentially introduce or extract fluid from inner or outer layers of the coiled substrate, depending on which direction the traveling field DEP. moves the particles. For example, fluid can be introduced through inlet ports corresponding to the outer layers of the coiled substrate. Traveling field DEP can be used to move target particles toward the inner layers of the coiled substrate. Accordingly, fluid extracted from the inner layers should have significantly higher concentrations of the target particle than fluid extracted from the outer layers. The outlet manifold can be configured to direct fluid extracted from the inner layers to a first reservoir, and direct fluid extracted from outer layers to a different reservoir.

In some embodiments the system can include overlapping electrode arrays. Overlapping electrode arrays refer to arrays that are disposed over the same area of a substrate, but are electrically isolated from each other. In operation, by applying appropriate traveling wave signals to each array, the system can apply a dielectrophoretic force in two non-parallel directions. In one embodiment, for example, where the electrodes arrays are of interdigitated electrodes and are oriented orthogonally to each other, the particles can experience two dielectrophoretic force vectors parallel to the plane of the substrate wherein the force vectors are perpendicular to each other. More generally, the electrode arrays can be oriented to apply forces at non-perpendicular angles.

Using overlapping electrodes, the system can shepherd particles to specific locations of the substrate, e.g., adjacent particular outlet channels in the chamber.

In some embodiments, additional electrode arrays are included on a substrate surface close to the chamber's outlet manifold. Trapped target particles can be released by the primary electrode arrays and re-trapped on the additional electrode arrays close to the outlet. These particles can subsequently be flushed from the filter without having to flush the entire chamber. Flushing the target particles from the chamber in a reduced volume of fluid increases the particle concentration.

The particles may include other types of biological particles. For example, particles can include cells, or components of cells and/or microorganisms. Examples of cells include prokaryotic and eukaryotic cells, including plant, insect, and mammalian cells. Examples of components of cells include proteins and DNA. Examples of microorganisms include bacteria. Examples of biological particles also include pathogens, such as viruses.

Particles can also be polymeric. For example, the particles may include polymer microspheres (e.g., polystyrene microspheres).

Particles can be solid, semi-solid, liquid or gaseous. Examples of solid particles include aforementioned polymer spheres or protein macromolecules. Examples of semi-solid particles include poly-acrylamide or agar gel particles. Examples of liquid particles include the dispersed phase in an emulsion, such as oil droplets in water or liquid particles in an aerosol, and examples of gaseous particles include the dispersed phase in a foam, such as gas bubbles in a liquid.

In some embodiments particles can be tagged with an antibody-coated moiety, such as a gold label or a polymeric bead, whose presence on the surface of the target particle changes the intrinsic dielectric properties of the particle and improves the purity and recovery of the separation process. Particles can be tagged for use with fluorescent microscopy techniques, or tagged with a magnetic moiety for separations that combine dielectrophoretic forces with magnetic ones.

Particle size may vary. Particles are generally sufficiently small to pass between the gap between surfaces of adjacent layers of the coiled substrate. In some embodiments, particles are large enough to be observed using optical microscopy (e.g., larger than about 0.5 microns in diameter, such as 1 micron or larger). In some embodiments, particles can be larger than about 1 millimeter in diameter.

Devices according to this invention, such as those described above, can be used in numerous applications. For example, dielectrophoretic filters can be used for drug discovery. Typically, in drug discovery applications, the dielectrophoretic response of a cell population is studied in response to various compounds. A change in a cell's DEP response may reflect a favorable or unfavorable reaction to a compound.

A parameter that can be used to characterize a DEP response of a cell or other bioparticle is the DEP ‘cross-over’ frequency. If the electrodes are energized at a frequency lower than this ‘cross-over’ frequency, a cell will experience a negative DEP force that repels it from the electrodes. At a frequency higher than the ‘cross-over’ frequency, the cell will experience a positive DEP force that will attract it to the electrodes. This change in DEP response can alter the way that these cells are collected or eluted from a DEP chamber as a function of the frequency of the electrical signals applied to the electrodes. Thus, a DEP chamber may be used to screen how T cells respond to various compounds that may initiate cell activation or changes in the cell cycle population kinetics of a suspension of cells. In some embodiments, a DEP chamber may also be used to detect and quantify the chemical inducement of apoptosis (see, e.g., Electrochemistry, volume 71, pages 203-205 (2003)).

Another application example is in diagnostics. In diagnostic applications, a DEP device can be used to increase the concentration of a particle population. For example, where one is investigating a type of bacteria in blood, one can use DEP to increase the concentration of the bacteria to a level suitable for subsequent investigation methods. To do this, one can use a relatively small volume DEP chamber to trap the bacteria while analyzing a large volume sample of blood. The fluid retained in the chamber will have an increased concentration of the bacteria compared to the original blood sample. Purging the chamber then provides a sample for diagnostic work. An example of how positive DEP can be used to attract the bacteria M. luteus to an electrode array, while repelling blood cells from the same electrode array, has been described in Journal of Applied Physics D, volume 26, pages 1278-1285 (1993). Cheng and coworkers have described essentially the same effect for the case of E. coli mixed with blood cells in Nature Biotechnology, volume 70, pages 2321-2326 (1998).

A further application example is in cell therapy. In cell therapy, a DEP chamber can be used to separate different types of cells from other cells in a sample. An example of this is separating stem cells from a sample including a mixture of stem cells and other cells. The DEP chamber can be operated under conditions at which stem cells are trapped in the filter while the rest of the sample is passed. Subsequent purge of the chamber provides a high purity sample of the stem cells. An example of using DEP to separate and enrich stem cell subpopulations from peripheral blood has been described by Stephens and coworkers in Bone Marrow Transplantation, volume 18, pages 777-782 (1996).

There are numerous applications for using DEP to position large numbers of cells or particles into arrays. No tool currently exists which can position large (>1000's) numbers of small particles into an arbitrary array with the ability to position the particles individually or in groups. Additional potential uses for this technology include the integrated circuit industry (e.g., for positioning large numbers of small, prefabricated components on a circuit); the medical diagnostics industry (e.g., for quickly and efficiently constructing cell-based devices to precise specifications); the military (e.g., for construction of cell-based biosensors for the detection of biological and chemical warfare agents); and the like. In general, any industry which requires the assembly of particles too small to effectively array with robotics or by human hands, or any industry which needs to position large numbers of particles simultaneously in an arbitrary array, will find DEP trapping useful.

We have demonstrated that different types of cells can be patterned into arbitrary arrays using dielectrophoresis.

Arrays of cells positioned using dielectrophoiesis are highly controllable. One single cell is trapped at each electrode when electrode dimensions are smaller than cell diameters, allowing single cell precision in the pattern formed.

In the case that the trapping of multiple particles at each electrode is desired, electrodes larger than 1 particle diameter can trap multiple particles.

Various techniques to pattern surface chemistry can be combined with DEP patterning to further influence or restrict cell location and locomotion after DEP trapping. These techniques include, but are not limited to, microcontact printing, protein adsorption, and lithography-based techniques.

DEP cell trapping using low voltages, as described herein, does not significantly harm at least some cell types, as demonstrated by their normal proliferation and morphology.

The electrodes used for DEP trapping could also be used to stimulate cells electrically or record electrical signals from the cells. For example, a culture of cardiac cells could be stimulated at select locations. A functional network of neuronal cells, being unpatterned or patterned with DEP, could be stimulated with electrical impulses delivered via the DEP electrodes and then the propagation of these signals could be analyzed via DEP electrodes.

Because DEP is activated by electric impulses, the traps can be arbitrarily turned on or off individually or in groups. Thus, cells can not only be trapped at will, but can be releases at any given time. This could be useful in systems that need to capture a cell temporarily to analyze it, and release it depending on analysis results (such as a FACS sorter or system to collect rare cells from a mixed population).

The electrodes used for DEP trapping could be used to lyse or electroporate adherent cells, either selectively or throughout the substrate. Electroporation of cells on the electrodes could facilitate transfection, either selectively or throughout the substrate.

DEP trapping can be used to align cells or other particles with detection or stimulation elements. Such detectors or stimulators may be optical, chemical, electrical, mechanical, magnetic, or thermal, or be based on other principles.

DEP is actuated by electricity, and is therefore easily integrated with computer control and other electronics.

DEP trapping can be actuated by low voltages (<5V) and can therefore be controlled by standard CMOS circuitry.

DEP trapping is applicable to solids, semisolids, or liquids suspended in liquids or gasses, provided that the suspended particle or droplet has different electrical characteristics than the surrounding substance.

DEP trapping of arrayed cells can occur in parallel, with the entire array being trapped simultaneously.

The electrodes can be wired to be controlled individually, so that each DEP trap on a substrate can be actuated independently of the others, to array cells serially, with individual cells or groups of cells being trapped at different times.

DEP can place cells or other particles on top of a cell layer or other intervening layer, allowing 3D constructs to be built from multiple layers.

As demonstrated by functional DEP trapping with or without a silicon dioxide passivation layer, trapping can occur with direct contact between cells and electrodes or with an intervening layer, which may serve to provide uniform surface chemistry and/or protect the cells from potential adverse effects of direct contact with active electrodes.

Precise, single cell positioning by DEP allows cell alignment with detection and/or stimulation elements during the construction of cell-incorporating devices, such as biosensors.

Multiple types or groups of cells or other particles can be patterned on the same substrate using DEP, through independent actuation of individual traps of groups of traps. For example, cells of type A could be trapped on electrode set A, while other electrodes present were not actuated. After washing away untrapped cells of type A, cells of type B could be trapped on newly actuated electrode set B. Cells of type A could be held on electrode set A by cell adhesion forces and/or continued actuation of electrode set A. This process could be repeated with cells of type C and so on. Trapping of multiple cell types will facilitate the construction of automated cell screens and the study of both hemotypic and heterotypic cell interactions.

DEP can facilitate the patterned delivery of non-cellular particles, such as beads, DNA, RNA, or proteins, to cells or other biological or non biological elements present on the substrate.

DEP trapping of multiple types of cells can facilitate combinatorial biology in which the interactions between every possible combination of several cell types are analyzed simultaneously, allowing for high throughput experimentation.

DEP trapping can be used to deliver non-cell particles to cells patterned with DEP or by other means. For example, multiple types of beads loaded with bioactive, or potentially bioactive, compounds could be positioned many cells or groups of cells. The response of these cells of groups of cells to these compounds could then be assayed in parallel, allowing for high throughput data collection. One or more compounds could be delivered to each cell or group of cells.

Fluid (gas or liquid) flow may be used as a destabilizing force to remove untrapped cells from a substrate following DEP patterning.

Gravity may be used as a destabilizing force to remove untapped cells from a substrate following DEP patterning. The effective force due to gravity may be increased with centrifugation or other acceleration.

Magnetic attraction or repulsion may be used as a destabilizing force to remove untrapped cells from a substrate following DEP patterning.

Vibration or other acceleration maybe used as a destabilizing force to remove untrapped cells from a substrate following DEP patterning.

DEP traps may be fabricated as part of planar or non planar surfaces.

A variety of construction methods may be utilized to achieve the “post-and-lid” electrode geometry used to trap cells or other particles with DEP. The “post-and-lid” electrode geometry used to trap cells or other particles with DEP will function using a variety of dimensions, including variations in the dimensions of chamber height, electrode height, electrode width, and electrode spacing.

Because DEP trapping is orthogonal to surface adhesiveness and other surface chemistry, DEP can trap cells only on a subset of adhesive areas. This phenomenon will be useful for sensor construction, as cell-free adhesive areas can be used to provide a reference signal with which to compare cell-containing areas.

DEP trapping can be used to create defined starting positions for cells whose locomotion is not confined after trapping.

DEP trapped particles need not be adhered to the surface containing the traps. For example, particles can be trapped before the electrodes are inverted and then turned off. Particles which are heavier than the surrounding media will fall onto an opposing surface. This phenomenon greatly expands the selection of surfaces on which to place or adhere the trapped patterned particles. In the case that particles are lighter than the surrounding media, the DEP substrate may trap the particles while inverted (facing downward) and then be flipped over, before turning the traps off. Once the traps are turned off, the light particles will rise and contact the opposing surface.

DEP trapping of cells can place a majority of cells in any desired arrangement. Although prior art techniques such as patterned surface chemistry will place a minority of cells in a desired arrangement, this limits analysis of such correctly placed cells to in situ assays. With DEP, since a majority of cells are placed correctly, the cells can be pooled for bulk assays such as Western Blots, Southern Blots, Northern Blots, and ELISAs.

Because DEP trapping allows precise control over cells number, the technique will greatly increase the integrity of the data collected from sensors or ether devices whose outputs are proportional to cell number, by reliably controlling this number.

DEP can be used to create an arbitrary and controlled stoichiometry of particles in a given region. Physical walls, wells, or a discontinuity in the surrounding media can then be used to further separate such regions.

DEP trapping of one or more cell types can be used to create functional biological constructs, such as a functional nerve chip or other construct where biological function depends on correct cell position, geometry, or type.

DEP trapping can be used to create arrays of particles smaller than 0.1 nm in size, 0.1-10 nm in size, 10 nm to 100 nm in size, 100 nm to 1 micron in size, 1 micron to 10 microns in size, 10 microns to 100 microns in size, or 100 microns to 1000 microns in size, larger than 1000 microns in size, or composed of multiple sizes.

DEP trapping can be used to create arrays of 1-10 particles, 10-100 particles, 100-1000 particles, 1000-10000 particles, 10,000-100,000 particles, 100,000-1,000,000 particles, 1,000,000-100,000,000 particles, or more than 100,000,000 particles.

DEP electrodes may be fabricated from metals or other conductive materials.

DEP trapping allows the use of both DC and AC electric fields. DEP trapping allows the use of both low and high frequency fields. With high frequency fields, electrical effects on cell membranes are minimized, allowing the application of relatively strong electrical fields without cell health effects.

After DEP trapping, cells or subcellular areas can be exposed to different stimuli than other cells or subcellular areas.

The electrodes used to trap cells using DEP can also be used to lyse a predetermined or selected population or subpopulation of cells for subsequent analysis with a standard or nonstandard biological assay, while excluding non-lysed cells. Alternately, cells left behind after other cells are lysed can be removed via electrical lysis or other methods such as trypsin treatment. In the case or cell removal via trypsin or other non-destructive methods, the cells can be subsequently analyzed or cultured on the same surface or another surface, or in solution.

The counter electrode (“lid”) placed near the “post” electrodes which are used for particle trapping need not be continuous. The “lid” electrode might, for example, be in the form of a mesh or separate elements, which would permit the passage of particles and the surrounding media, or only the surrounding media.

DEP-based trapping provides a method by which the initial locations of cells or other particles on are surface are determined by the locations of active traps. Later, the positions of particles of cells may remain the same or be determined by DEP or other forces.

The “post-and-lid” apparatus described for performing DEP-based trapping can be fabricated by any method which produces a suitably similar device. As shown by the Examples herein, the “post-and-lid” apparatus can be manufactured easily using existing technology.

The commercial sector will benefit from the ability to pattern multiple cell types in order to creating functional tissue engineering constructs, such as fully functional nerve chips. Additional commercial interest will stem from the ability to position cells on or within biosensors and other cell based devices, allowing construction to exacting design specifications, including the alignment of cells with detection and stimulation elements comprising the device, especially in the case of MEMS (MicroElectroMechanical Systems). With an increased interest in the analysis of individual cells, arrays of individual cells will allow such analysis to proceed in a massively parallel, high throughput format.

By controlling the distribution of cells with electrical forces, it is possible to engineer cell cultures in a more complicated and precise manner than was previously possible. For example, cells can be initially positioned in a straight line to facilitate straightforward analysis of cell migration on a population level. The density of cells on the line can be varied to examine how cell-cell contact affects the migration response. With the addition of adhesiveness (surface-chemistry) patterning, cells could be placed by DEP in a subregion of the adhesive areas to observe spatially directed spreading or migratory behaviors. With arrays of dielectrophoresis-based traps, the biological effects of cell packing can be studied. Because the electrodes driving dielectrophoresis (DEP) can be independently energized, multiple cell types could be patterned separately.

In order for DEP to function as an effective patterning technique, cells must be manipulated without adverse effects. As others have observed, cells are able to withstand electric fields of suitably low amplitude and high frequency [4]. We did not observe adverse effects on cell viability, even when cells were subjected to DEP at higher voltages and longer periods than were necessary for patterning.

The integration of living cells into bioMEMS requires precise and robust processes to pattern cells in alignment with the analytic components of these devices. Currently, the simultaneous positioning of large numbers of cells typically relies on three techniques: patterning surface chemistry such that cells preferentially adhere to adhesive regions, allowing cells to settle into depressed wells, or controlling fluid flow such that cells are localized only to certain streams and therefore certain regions of the substrate. None of these methods can control the placement of individual cells. We describe a method to move living cells safely and rapidly to precise locations using electrodes constructed with standard microfabrication techniques. Small potentials applied to the electrode array result in dielectrophoresis (DEP), the force on polarizable bodies in a nonuniform electric field. Positioning cells using electrical forces is inherently well suited for integration into computer controlled chip-based devices. Potential applications range from functional nerve chips to automated cell interaction screens.

DEP functions by exerting electrical forces of particles which may be either charged or electrically neutral. When such a particle enters an electrical field, it becomes polarized. If the electrical field is non-uniform, a particle which is more polarizable than the surrounding fluid or gaseous media is pulled toward the stronger region of the field, undergoing positive DEP. A particle which was less polarizable than the surrounding fluid of gaseous media would be pulled towards the weakest region of the electric field, undergoing negative DEP.

The present invention is able to achieve single particle trapping in a format which is arrayable and combinable with other patterning techniques, such as patterned-surface chemistry. The two-layer, “posts-and-lid” geometry involved in the-current technique makes it uniquely suitable for the production of arbitrary arrays, since particle positions are not restricted by a the geometry used to create the non-uniform electric field needed to achieve DEP.

### EXAMPLES

Because most cell types become motile after they adhere to a planar surface, we have combined DEP patterning with patterned substrate adhesiveness in order to preserve the fidelity of the pattern after cells adhere to the substrate. Cell adhesion to a surface after DEP trapping has not previously been demonstrated, with or without the addition of adhesiveness patterning.

NIH/3T3 fibroblasts (3T3s, ATCC CPI 1653) and bovine pulmonary arterial endothelial cells (BPAECs, VEC Technologies, Rensselaer, N.Y.) were cultured under 5% and 10% CO₂ atmospheres, respectively. All cells were cultured in Dulbecco's modified Eagle's media supplemented with 10% calf serum, 100 U/mL penicillin, and 100 μg/mL streptomycin (Life Technologies). Prior to plating on experimental substrates, cells were detached using 0.25% trypsin and 1 mM ethylenediaminetetraacetic acid (EDTA). Prior to being subject to dielectrophoresis trapping, cells were resuspended in DEP Media consisting of 300 mOsm sucrose with 1% calf serum. Once cells adhered after the trapping, the media were switched back to those listed previously.

### Example 1

### Preparation of Substrates

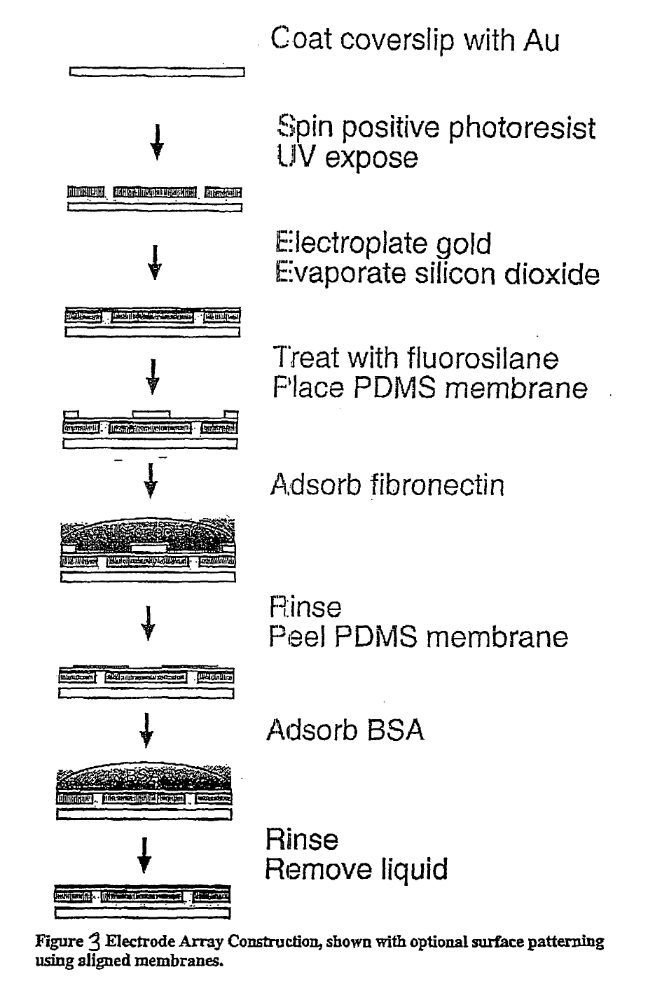

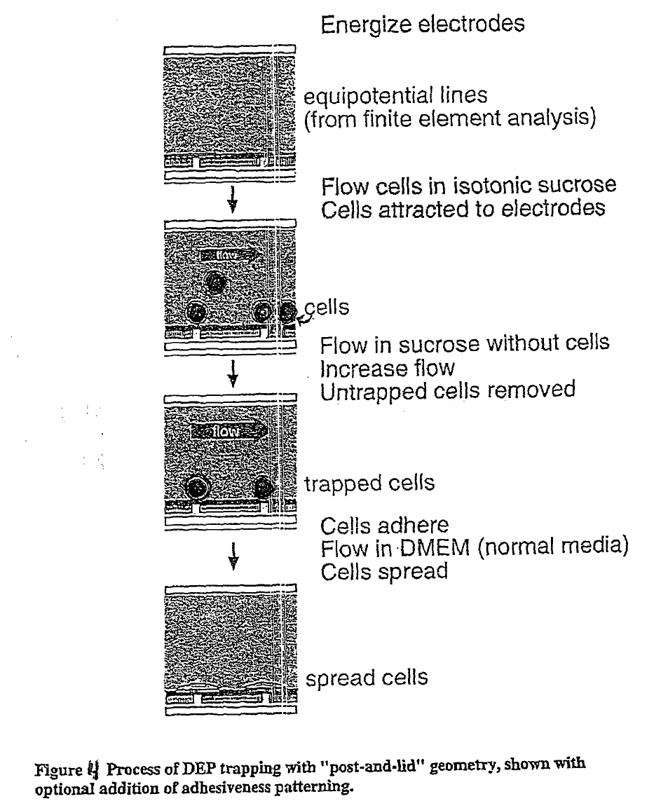

Substrate fabrication, as illustrated in FIG. 3, began with the deposition of 50 angstroms of titanium followed by the deposition of 150 angstroms of gold, both at a rate of 1 angstrom/second, onto 22 by 60 mm #1.5 coverslips. Metal deposition was accomplished via electron beam evaporation. The metal-coated coverslips were treated with plasma in an evacuated plasma etcher for 1 minute, and then treated with 20% hexamethanedisilazane in propylene glycol methyl ether acetate for 1 minute. Next, Shipley 1813 photoresist was spin coated at 2500 rpm for 15 seconds, to achieve a thickness of ˜1.2 microns. The resist was baked at 100° C. for 5 minutes.

To generate a pattern, the resist was covered with a standard chrome-on-gold mask, having 3 micron circles corresponding to the 3 micron wide electrodes, and exposed to 3 mJ/cm² collimated, broadband UV light using a mask aligner. After exposure, the resist was developed in “351” developer, diluted 1:5 in water, for 45 seconds, and then rinsed with water. Substrates were then treated with plasma in an evacuated plasma etcher for 30 seconds.

The gold comprising the traps was then electroplated onto the flat gold layer underneath the photoresist. Electroplating was accomplished using TG25E plating solution from Technics, inc. The plating current was set at 1 mA/cm² for 18 minutes. Substrates were then rinsed with water. Cross-linking of the photoresist was achieved by heating the substrates to 160 C and simultaneously exposing them to 1.5 mW/cm² UV irradiation for 6 minutes. After electroplating, some substrates were coated with a 300 angstrom layer of silicon dioxide, via electron beam evaporation, at a rate of 3.5 angstroms/second.

The adhesiveness of the substrates was patterned, in alignment with the electrodes, by depositing fibronectin or collagen to form adhesive regions and depositing bovine serum albumin or Pluronics F127 (from BASF Corp.) in other areas to form non-adhesive regions. Protein deposition was accomplished via either microcontact printing or adsorption through an elastomeric membrane. Microcontact printing was accomplished via a technique similar to that described by Folch et al (A. Folch and M. A. Schmidt, IEEE Journal of Microelectromechanical Systems 8:85-89 (1999)). Briefly, a PDMS stamp was affixed to a glass backing to prevent distortion, coated with the protein, and then pressed against the substrate to transfer the protein. Alternately, the substrate was covered with an elastomeric membrane, as described by Duffy et al (D. C. Duffy et al., Advanced Materials 11:546-552 (1999)). Protein was then adsorbed through patterned holes in the membrane. After adsorption, the membrane was removed, leaving protein adsorbed only to the regions not previously covered by the membrane. Membranes were composed of a layer of PDMS, used to reversibly adhere to the substrates, and a layer of epoxy, to prevent distortion.

After adhesive protein was patterned using microcontact printing of adsorption through membranes, areas not covered with protein were rendered non-adhesive by the adsorption of either 0.2% Pluronics F127 or 1% BSA in water for 1 hour.

### Example 2

### Trapping of Cells

Electrodes were placed in a parallel plate flow chamber, in which the pattered electrode described above was positioned ˜100 microns from an unpatterned electrode composed of a layer of gold on glass. This configuration is referred to as “posts and lid” Since the electrodes are in the shape of posts, and the counterelectrode forms the “lid” of the flow chamber. Fluid flow was used both to introduce cells to the substrate, and to remove untrapped cells after DEP trapping was complete. The DEP media, introduced using a 3 mL syringe, was gradually increased until untrapped cells were washed away.

Cell health was assessed by comparing the proliferation rates and morphology of cells undergoing DEP with those not undergoing DEP. Phase contrast images of cells were taken using a cooled CCD camera (SpotRT Slider, Diagnostic Instruments) attached to an inverted microscope (Eclipse TE200, Nikon) with a 4× objective. Cells were counted manually from these images.

Electric Fields were modeled using finite element analysis software (FlexPDE 3 by PDE solutions).

### Results:

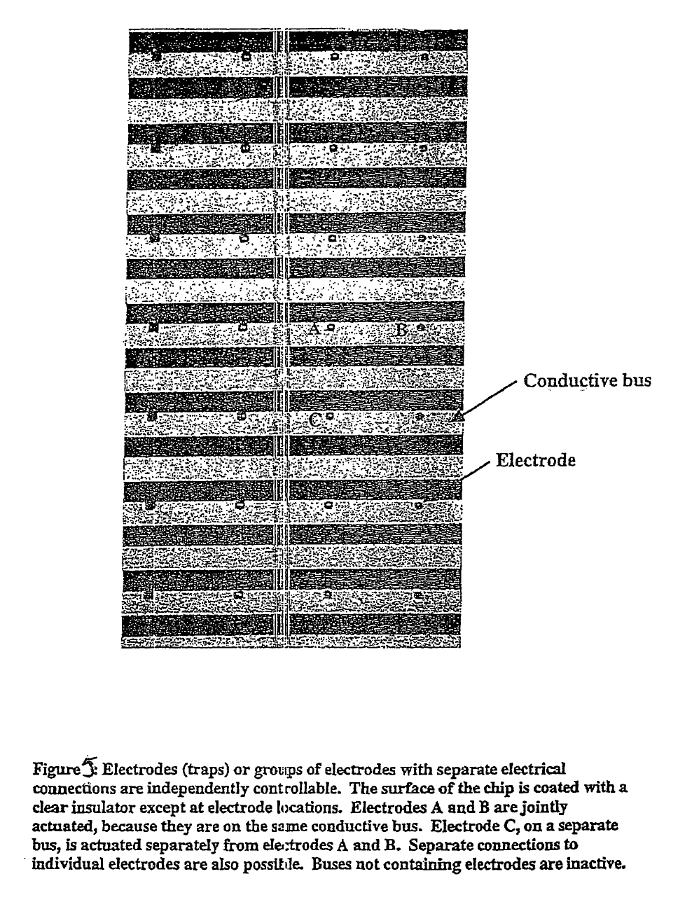

BPAEC's and 3T3 Fibroblast cells were trapped in 2D arrays by DEP with single cell precision (FIG. 4). Electrodes were typically energized with 5 volts at 2 MHz, although 1-10 volts at 0.1-10 MHz also provided effective trapping. Other cell types could also be patterned using DEP. Trapping of single cells required electrode dimensions smaller than the cell size (˜10 microns). When larger electrodes were used, multiple cells were trapped at each site. However, the exact size of the electrodes was unimportant as long as the width of the electrode was smaller than the diameter of the cell. Other device dimensions such as chamber height, electrode spacing, and electrode height were not critical, although trapping strength increased with decreasing chamber height. Arrays as large as 1 cm by 1 cm have been constructed, although this size was chosen arbitrarily and does not represent a fundamental or practical limit. Cell trapping on 1 cm by 1 cm arrays took approximately 10 minutes.

In some cases, the entire substrate surface was coated with a 300-angstrom layer of silicon dioxide, providing a uniform surface chemistry and removing the cells from direct contact with electrodes. To restrict cell location after DEP trapping, the adhesiveness of some substrates was patterned in registration with the DEP traps. The locations and geometries were limited only by the resolution of the technique used to pattern the adhesive protein. Cell positions were confined to adhesive areas (data not shown).

The health of cells trapped with DEP (5 volts at 2 MHz) was not adversely affected, as seen by previous investigators (see, e.g., Glasser and Fuhr, Bioelectrochem. Bioenerg. 47:301-310 (1998)). Cells to be analyzed for potential toxic effects were subjected to DEP at 10 volts for 5 minutes. At this point, the DEP device was removed from the power source and placed in a tissue culture incubator. Cells were inspected after 15 hours and again after 72 hours. No unusual blebbing, vesicles, or other morphological evidence of adverse health effects were observed. Cell division rates were similar to tissue culture controls, indicating that cell health was not affected by DEP or other manipulations involved in the patterning process.

Proliferation rates were similar among cells trapped with DEP in DEP Media versus untapped cells cultured in standard culture media. Cell morphologies were also indistinguishable. Since division rates and morphologies are broadly indicative of cell health, we conclude that cells are not adversely effected by DEP trapping or the DEP media.

### Example 3

We have also constructed electrodes with independently switchable sets of traps (FIG. 5). Such electrodes are capable of patterning multiple cell populations in order to study heterotypic cell interactions or create functional tissue constructs and cell-based device. In FIG. 5, electrodes (traps) or groups of electrodes with separate electrical connections are independently controllable. The surface of the chip is coated with a clear insulator except at electrode locations. Electrodes A and B are jointly actuated in this embodiment, because they are on the same conductive bus. Electrode C, on a separate bus, is actuated separately from electrodes A and B. Separate connections to individual electrodes are also possible. Buses not containing electrodes are inactive.

### CONCLUSIONS

We have demonstrated DEP as a safe and effective means of patterning mammalian tissue culture cells independently from the surface characteristics the substrate. Cells can be patterned in arbitrary locations with single cell precision. This type of patterning allows greater control over cell placement than previous patterning schemes, and is particularly powerful for the investigation of heterotypic cell-cell interactions. Experiments with DEP will also be used to further define the interactions between living cells and artificial surfaces. Because DEP is controlled by small electric potentials, it is inherently suited for integration into computer controlled, lab-on-a-chip devices.

The contents of all patents, patent applications, and literature references cited herein are hereby incorporated by reference.

Other embodiments are within the following claims.

What is claimed is:

1. An apparatus for arraying particles, the apparatus comprising:
a) a substrate comprising an array of electrodes;
b) a counter-electrode plate substantially parallel to the array of electrodes; and
c) a fluid inlet for permitting a particle-containing fluid to flow between the array of electrodes and the counter-electrode plate.

2. The apparatus of claim 1, wherein the apparatus further comprises a voltage source for applying a voltage between the array of electrodes and the counter-electrode.

3. The apparatus of claim 2, wherein the voltage source provides a voltage of not greater than about 100 volts/mm.

4. The apparatus of claim 1, wherein the substrate comprises at least one cell-adhesive region and at least one non-cell-adhesive region.

5. The apparatus of claim 1, wherein the cell adhesive region comprises a layer of fibronectin or collagen.

6. The apparatus of claim 1, further comprising a fluid outlet.

7. The apparatus of claim 1, wherein the electrode array comprises at least 50 electrodes.

8. The apparatus of claim 1, wherein the electrode array comprises at least 100 electrodes.

9. The apparatus of claim 1, wherein each electrode of the electrode array is less than 100 microns in diameter.

10. The apparatus of claim 1, wherein each electrode can be energized independently.

11. A method for arraying particles on a surface, the method comprising:
a) providing an apparatus comprising:
i) a substrate comprising an array of electrodes;
ii) a counter-electrode plate substantially parallel to the array of electrodes;
iii) a fluid inlet for permitting a flow of particle-containing fluid between the array of electrodes and the counter-electrode plate;
b) flowing a particle-containing fluid between the array of electrodes and the counter-electrode plate; and
c) subjecting the fluid to an electric field by applying an electric potential to the array of electrodes under conditions such that particles in the fluid are arrayed on a surface of the substrate.

12. The method of claim 11, wherein the particles are cells.

13. The method of claim 12, wherein the substrate comprises at least one cell-adhesive region and at least one non-cell-adhesive region.

14. The method of claim 13, wherein the cell adhesive region comprises a layer of fibronectin or collagen.
